(19) United States
(12) Patent Application Publication
(10) Pub. No.: US 2026/0048789 A1
(43) Pub. Date: Feb. 19, 2026

(54) STEERING KNUCKLE AND WHEEL HUB ASSEMBLY AND METHOD FOR REDUCING CORROSION BONDING

(71) Applicant: RB Distribution, Inc., Colmar, PA (US)

(72) Inventors: Ethan DiBona, Glenside, PA (US); William Hunt, North Wales, PA (US); Glenn Sincovich, Doylestown, PA (US); Stephen Miller, Glenside, PA (US)

(73) Assignee: RB Distribution, Inc., Colmar, PA (US)

(21) Appl. No.: 18/806,050

(22) Filed: Aug. 15, 2024

(51) Int. Cl. B62D 7/18; C23F 11/12

(52) U.S. Cl. CPC B62D 7/18; C23F 11/12

(57) ABSTRACT

A steering knuckle configured to receive a bearing having a given outer diameter. The steering knuckle includes a knuckle body having an exterior surface with a given surface treatment. The body defines a knuckle bore having an interior surface and configured to receive the bearing. At least a portion of the knuckle bore interior surface is covered with a corrosion resistant material.

### BACKGROUND

Referring to FIGS. 1-3, a steering knuckle 10 provides a connection between the wheel hub bearing assembly 20 and the vehicle's steering mechanism. The wheel hub bearing assembly 20 as illustrated includes a bearing 24 rotatably secured relative to the wheel hub 22. The wheel hub 22 includes an axle spline 26. The wheel hub bearing assembly 20 is passed through the knuckle 10 and the bearing 24 portion of the wheel hub bearing assembly 20 is positioned within the knuckle bore 13 such that there is an engineered fit with the interior surface 15 of the bore 13. The bearing 24 portion of the wheel hub bearing assembly 20 has an outer diameter BD which is substantially the same as the inner diameter KD of the bore 13. Fasteners 27 are used to secure the steering knuckle 10, back plate 25 and wheel hub bearing assembly 20 to each other.

In addition to the wheel hub bearing assembly 20, the steering knuckle 10 is also attached to control arms 12, tie rods 14, struts 16, brake calipers 18, and other components, for example, sway bars, trailing arms, end links and axles (not shown). As such, steering knuckle repairs can be time-consuming and expensive.

Some of the most common steering knuckle failures include collision/road damage and/or rust and corrosion. A defective steering knuckle may result in vehicle “shaking” when driving; misaligned steering wheel/vehicle pulling to one side; and/or uneven tire wear. Also, the bearings are a friction based assembly and are prone to wearing out with a limited service life.

When it is time for such a repair, it is often necessary to remove the bearing 24 portion of the wheel hub bearing assembly 20 from the knuckle bore 13, however, in practice such may prove very difficult. If the steering knuckle body 12 is manufactured from steel or the like, steel-steel corrosion bonding occurs between the bearing 24 and the interior surface of the knuckle bore 15, preventing smooth removal by the service technician. Similarly, even if the knuckle body is manufactured from a dissimilar material, e.g. an aluminum alloy, galvanic corrosion bonding occurs between the bearing 24 and the interior surface of the knuckle bore 15, again preventing smooth removal by the service technician.

### SUMMARY

In at least one embodiment, the present disclosure provides a steering knuckle configured to receive a bearing have a given outer diameter. The steering knuckle includes a knuckle body having an exterior surface with a given surface treatment. The body defines a knuckle bore having an interior surface and configured to receive the bearing. At least a portion of the knuckle bore interior surface has a corrosion resistant material applied thereto.

In at least one embodiment, the present disclosure provides a steering knuckle wherein the knuckle bore interior surface defines a minimum diameter which is larger than the given outer diameter such that a circumferential gap is defined between the knuckle bore interior surface and the bearing.

In at least one embodiment, the present disclosure provides a method of treating a steering knuckle including a knuckle body having an exterior surface with a given surface treatment, the body defining a knuckle bore having an interior surface and configured to receive the bearing. The method includes applying a corrosion resistant material to at least a portion of the knuckle bore interior surface.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a perspective view of a steering knuckle interconnected with corresponding vehicle components;

FIG. 2 is an exploded perspective view showing a prior art steering knuckle and wheel hub and bearing assembly;

FIG. 3 is a cross-sectional view of the assembly of FIG. 2;

FIG. 4 is a perspective view of a steering knuckle in accordance with an embodiment of the disclosure;

FIG. 5 is a perspective view of a steering knuckle in accordance with another embodiment of the disclosure;

FIG. 6 is a cross-sectional view along the lines 6-6 in FIG. 5;

FIG. 7 is a perspective view of a steering knuckle in accordance with yet another embodiment of the disclosure;

FIG. 8 is a plan view of a portion of the steering knuckle of FIG. 7;

FIGS. 9 and 10 are photographs of a steering knuckle in accordance with an embodiment of the invention having a steering knuckle manufactured from QT450-10 and the knuckle bore surface coated with a non-metallic, epoxy paint, with FIG. 9 showing the knuckle prior to salt spray testing and FIG. 10 showing the knuckle after salt spray testing;

FIGS. 11 and 12 are photographs of a steering knuckle in accordance with an embodiment of the invention having a steering knuckle manufactured from ALSi7Mg0.3 aluminum and the knuckle bore surface e-coated with a non-metallic, epoxy paint, with FIG. 11 showing the knuckle prior to salt spray testing and FIG. 12 showing the knuckle after salt spray testing; and FIGS. 13 and 14 are photographs of a steering knuckle in accordance with an embodiment of the invention having a steering knuckle manufactured from QT450-10 and the knuckle bore surface covered with Teflon®, with FIG. 13 showing the knuckle prior to salt spray testing and FIG. 14 showing the knuckle after salt spray testing.

### DETAILED DESCRIPTION

The ensuing detailed description provides exemplary example(s) only, and is not intended to limit the scope, applicability, or configuration of the herein disclosed example(s). Rather, the ensuing detailed description of the exemplary example(s) will provide those skilled in the art with an enabling description for implementing the exemplary examples in accordance with the present disclosure. It should be understood that various changes may be made in the function and arrangement of elements without departing from the spirit and scope of the invention, as set forth in the appended claims.

To aid in describing the disclosure and/or invention as claimed, directional terms may be used in the specification and claims to describe portions of the present disclosure and/or invention (e.g., upper, lower, left, right, etc.). These directional definitions are merely intended to assist in describing the example(s) and claiming the invention, and are not intended to limit the disclosure or claimed invention in any way. In addition, reference numerals that are introduced in the specification in association with a drawing figure may be repeated in one or more subsequent figures without additional description in the specification, in order to provide context for other features.

It should be understood that when an element is referred to as being “connected” or “coupled” to another element, it can be integral with the other element, directly connected or coupled to the other element, or that intervening elements may be present. In contrast, when an element is referred to as being “directly connected” or “directly coupled” to another element, it should be understood that no intervening elements are present. Other words used to describe the relationship between elements should be interpreted in a like fashion (e.g., “between” versus “directly between,” “adjacent”versus “directly adjacent,”etc.).

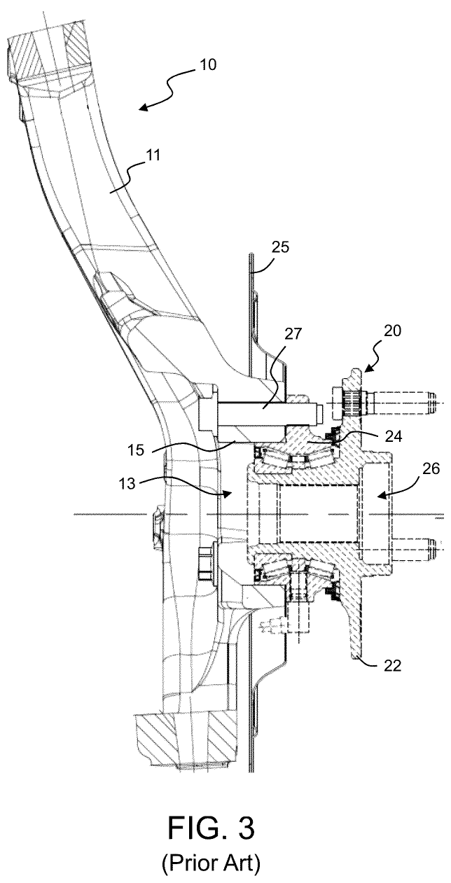

A first steering knuckle 50 in accordance with an embodiment of the disclosure will be described with reference to FIG. 4. The steering knuckle 50 has a body 52 which is shaped and configured to mate within a desired vehicle configuration. The body 52 can be manufactured from various metal materials, for example, steel, iron or aluminum, including alloys thereof, and has an exterior surface 51 with a desired surface treatment. The desired surface treatment may include no treatment, only the natural surface. A knuckle bore 53 is defined by the body 52 and is configured to receive a bearing 24 of a wheel hub and bearing assembly 20 as shown above. A support surface 55 is defined about the knuckle bore 53 and includes one or more bolt bores 57 configured for passage of mounting bolts (not shown) therethrough. The knuckle bore 53 defines an interior surface 54. In the present embodiment, the interior surface 54 has a minimum interior diameter KD′ which is larger than the outer diameter BD of the bearing 24. In this way, a circumferential gap is defined between the bore interior surface 54 and the bearing 24. The circumferential gap has a width in the range of 0.5 mm to 2.0 mm, and more preferably is between 0.7 mm to 1.2 mm.

In addition to the circumferential gap, the knuckle bore interior surface 54 is covered with a corrosion resistant material 56. With such covering, the interior surface 54 has a surface treatment which is distinct from the body exterior surface 51 surface treatment. The corrosion resistant material 56 may include various non-metallic materials, including, but not limited to, paints, epoxys, polymers, composites, thermoplastics (e.g. Teflon®) and the like, applied in liquid or solid form. The corrosion resistant material 56 may be applied using various techniques, including, but not limited to, brushing, spraying, surface e-coating (electrocoating, electrodeposition, or electrophoretic coating), dipping, adhering or the like. The corrosion resistant material 56 is applied with a layer thickness of between 0.05 mm to 1.5 mm, and more preferably is between 0.1 mm to 0.5 mm. With a circumferential gap and a corrosion resistant covering, the potential for corrosion bonding is greatly reduced, allowing for easy removal of the bearing 24 from the knuckle bore 53 if necessary during repair.

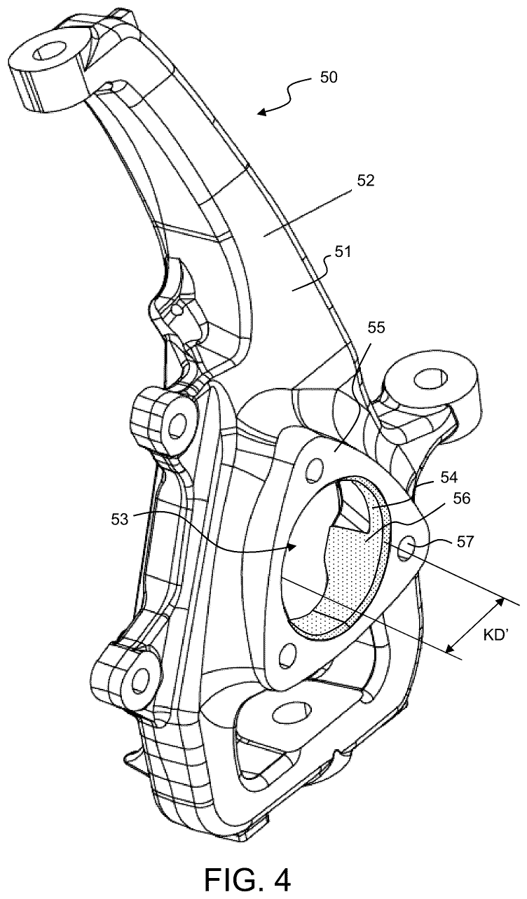

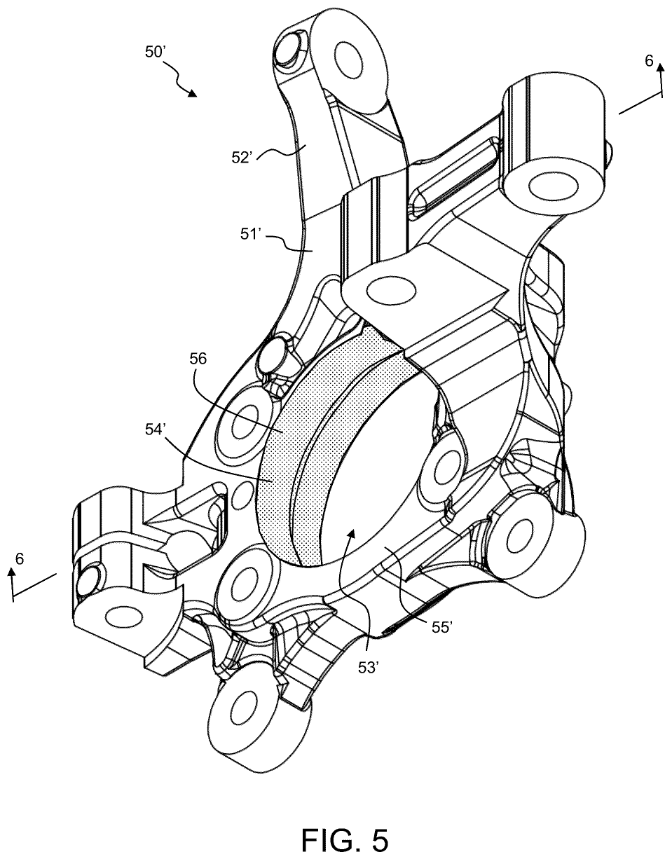

Referring to FIGS. 5-6, a steering knuckle 50′ in accordance with another embodiment of the disclosure will be described. The steering knuckle 50′ is similar to the previous embodiment and includes a body 52′ with an exterior surface 51′. It is seen that the knuckle body 52′ can have any desired configuration to mate with the intended vehicle. As in the previous embodiment, the body 52′ defines a knuckle bore 53′ with a support surface 55′ thereabout. Again, it is seen that the bore 53′ and support surface 55′ may have various configurations to mate with the intended vehicle. In the present embodiment, the bore 53″ has an interior surface 54′ with a stepped configuration with interior surface portions 54′a, 54′b, 54′c and a through bore 59 intersecting with the surface portion 54′c. In the present embodiment, the surface portion 54′c defines the minimum interior diameter KD′. Again, the minimum interior diameter KD′ is larger than the outer diameter BD of the bearing 24. In this way, a circumferential gap is defined between the bore interior surface 54′ and the bearing 24. The disclosure is not limited to the specific configurations illustrated and includes various configurations for various vehicles.

Similar to the previous embodiment, the interior surface 54′ of the knuckle bore 53′ is covered with a corrosion resistant material 56. The surface 54′ is shown with the corrosion resistant material 56 applied to all portions 54′a, 54′b, 54′c of the interior surface 54′, however, it is possible to cover only those portions 54′c which have the minimum interior diameter KD′ and are most susceptible to corrosion bonding. It is further noted that the through bore 59 is not covered, however, such may be covered, in whole or in part, for example, to simplify manufacture. As in the previous embodiment, the circumferential gap and corrosion resistant covering greatly reduce the potential for corrosion bonding, allowing for easy removal of the bearing 24 from the knuckle bore 53′ if necessary during repair.

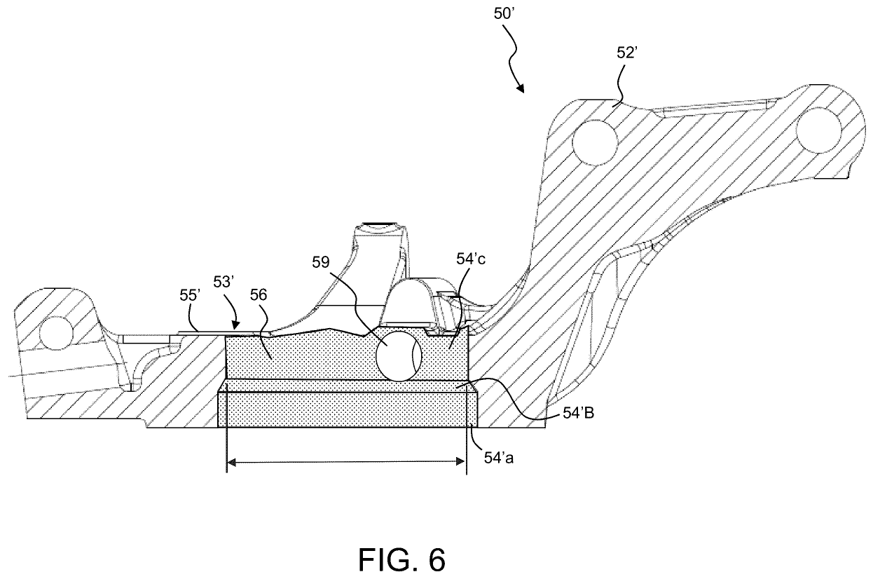

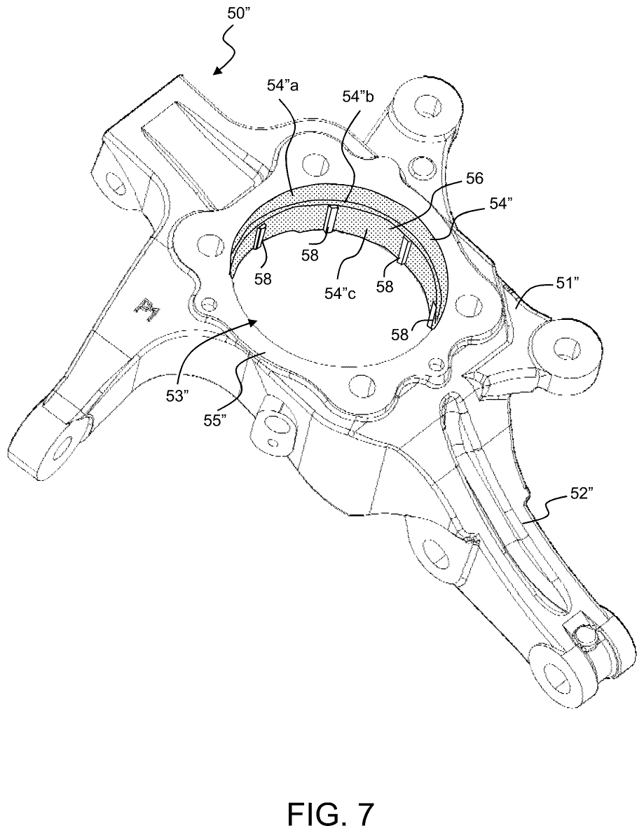

Referring to FIGS. 7-8, a steering knuckle 50″ in accordance with another embodiment of the disclosure will be described. The steering knuckle 50″ is similar to the previous embodiments and includes a body 52″ with an exterior surface 51″. Once again, it is seen that the knuckle body 52″ can have any desired configuration to mate with the intended vehicle. As in the previous embodiment, the body 52″ defines a knuckle bore 53″ with a support surface 55″ thereabout. Again, it is seen that the bore 53″ and support surface 55″ may have various configurations to mate with the intended vehicle. In the present embodiment, the bore 53″ has an interior surface 54″ with a stepped configuration with interior surface portions 54″a, 54″b, 54″c. In addition, a plurality of splines 58 extend radially inward from the surface portion 54″c. As in the previous embodiment, the surface portion 54″c defines the minimum interior diameter KD′ and the minimum interior diameter KD′ is larger than the outer diameter BD of the bearing 24. In this way, a circumferential gap 60 is defined between the bore interior surface 54″ and the bearing 24. In the present embodiment, the splines 58 extend within the gap 60 and have an interior diameter SD between the splines 58 which is closer to the outside diameter BD of the bearing, thereby reducing clearance with the bearing 24, but providing minimum surface contact between the bearing 24 and the knuckle bore 53″. The splines 28 also provide a machined surface to locate the wheel hub bearing assembly 20 for mounting to a achieve proper ABS sensor gap.

Similar to the previous embodiment, the interior surface 54″ of the knuckle bore 53″, is covered with a corrosion resistant material 56. In this embodiment, the splines 58 are purposely not covered, but used the control the amount of non-covered surface to locate the wheel hub bearing assembly 20 for mounting to achieve a proper ABS sensor gap. It is recognized that in some embodiments, the splines 58 may also be covered. The surface 54″ is shown with the corrosion resistant material 56 applied to all portions 54″a, 54″b, 54″c of the interior surface 54″, however, it is possible to cover only those portions 54″c which have the minimum interior diameter KD′ and are most susceptible to corrosion bonding. As in the previous embodiment, the circumferential gap and corrosion resistant covering greatly reduce the potential for corrosion bonding, allowing for easy removal of the bearing 24 from the knuckle bore 53″ if necessary during repair.

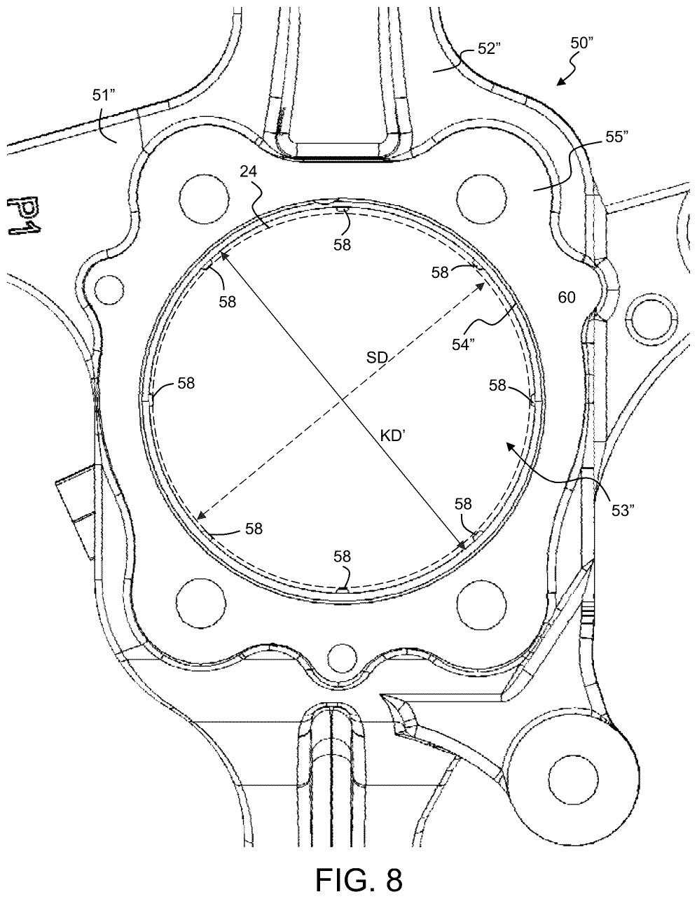

Referring to FIGS. 9-14, photographs of steering knuckles 50 in accordance with embodiments of the disclosure are shown prior to and after sea salt testing. Salt spray testing was performed per ASTM B117-07a and was observed and photographed at 24-hour intervals. The test was run for 96 hours utilizing a Singleton SCCH 22. The results can be seen in the referenced photos.

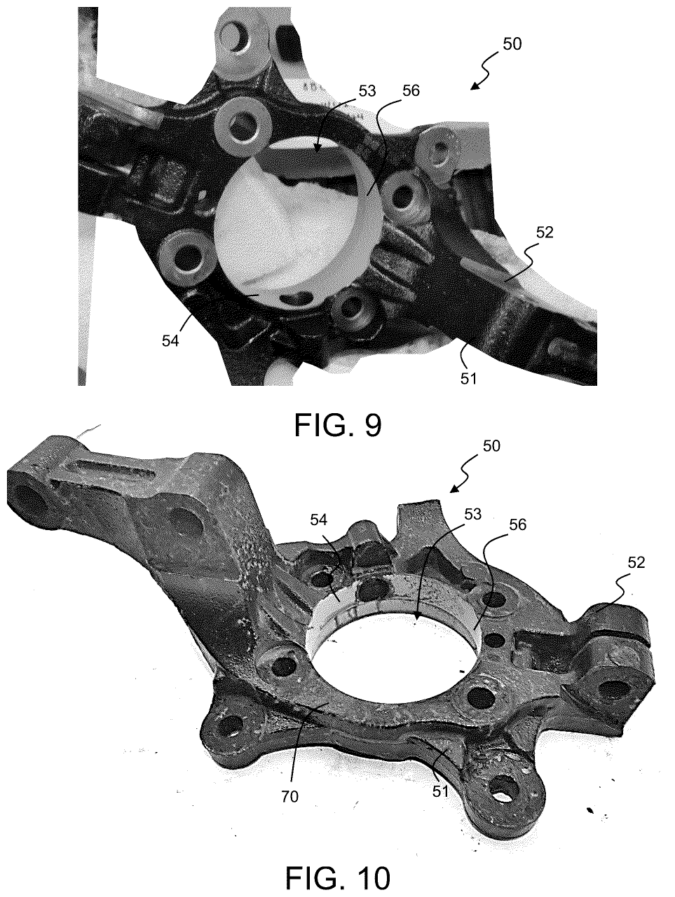

FIGS. 9 and 10 are photographs of a steering knuckle 50 in accordance with an embodiment of the invention having a steering knuckle manufactured from QT450-10 and the knuckle bore surface covered with a non-metallic, epoxy paint. FIG. 9 shows the knuckle 50 prior to salt spray testing and FIG. 10 showing the knuckle 50 after 96 hours of salt spray testing. As can be seen, substantial rust and corrosion 70 developed on the machined exterior surface 51 of the body 52, while the painted wheel bearing bore 53 is not rusted.

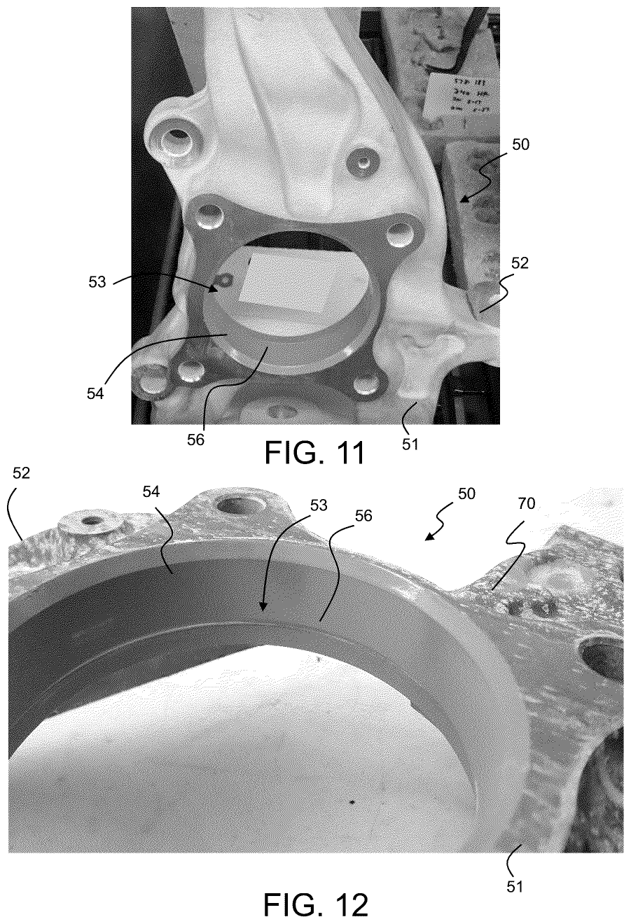

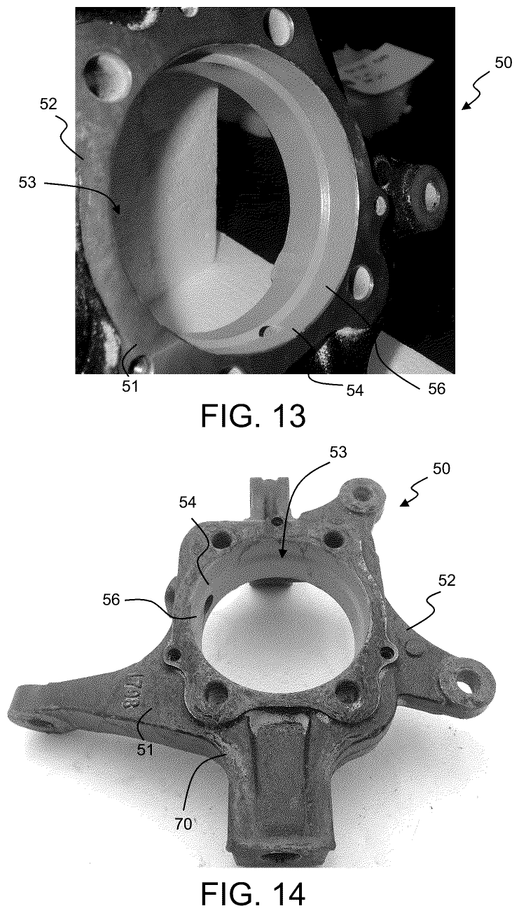

FIGS. 11 and 12 are photographs of a steering knuckle 50 in accordance with an embodiment of the invention having a steering knuckle manufactured from ALSi7Mg0.3 aluminum and the knuckle bore surface e-coated with a non-metallic, epoxy paint. FIG. 11 shows the knuckle 50 prior to salt spray testing and FIG. 12 shows the knuckle 50 after 96 hours of salt spray testing. As can be seen, substantial rust and corrosion 70 developed on the machined exterior surface 51 of the body 52, while the covered wheel bearing bore 53 is not rusted.

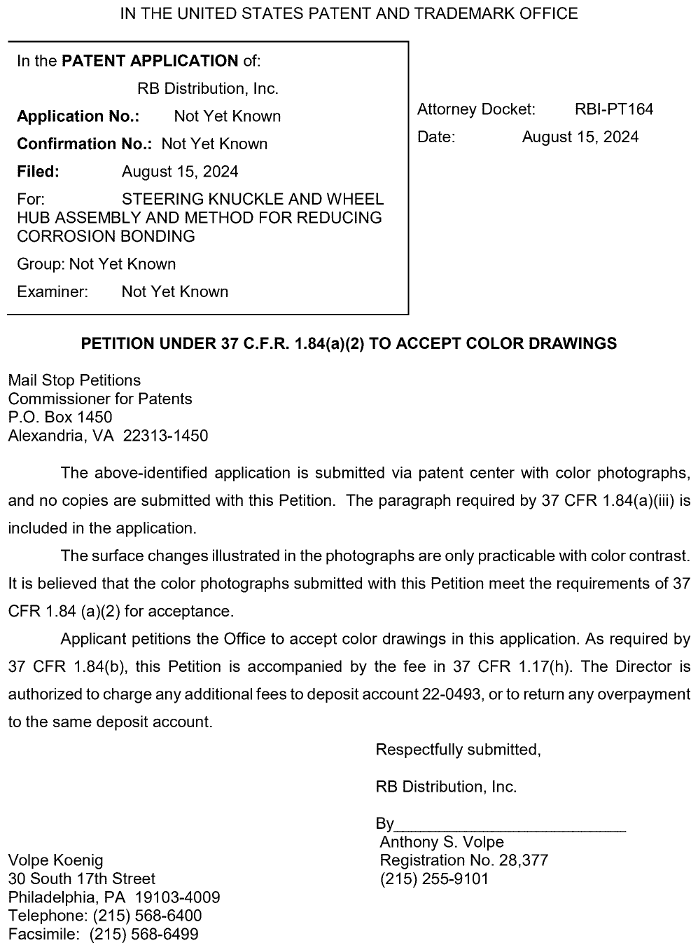

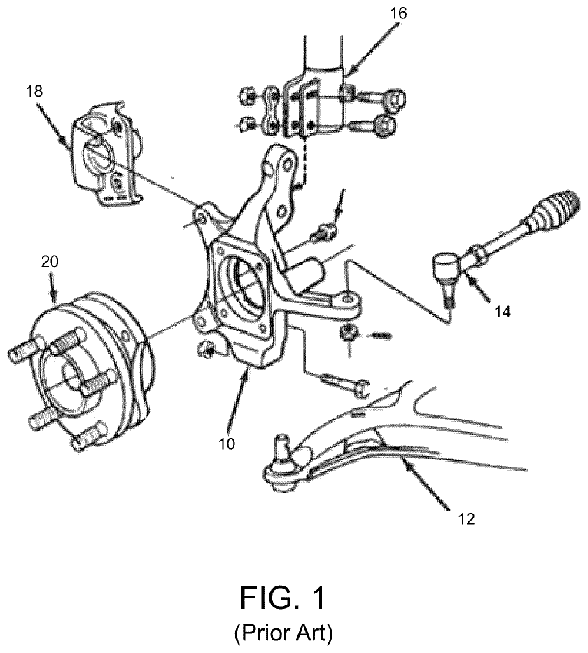

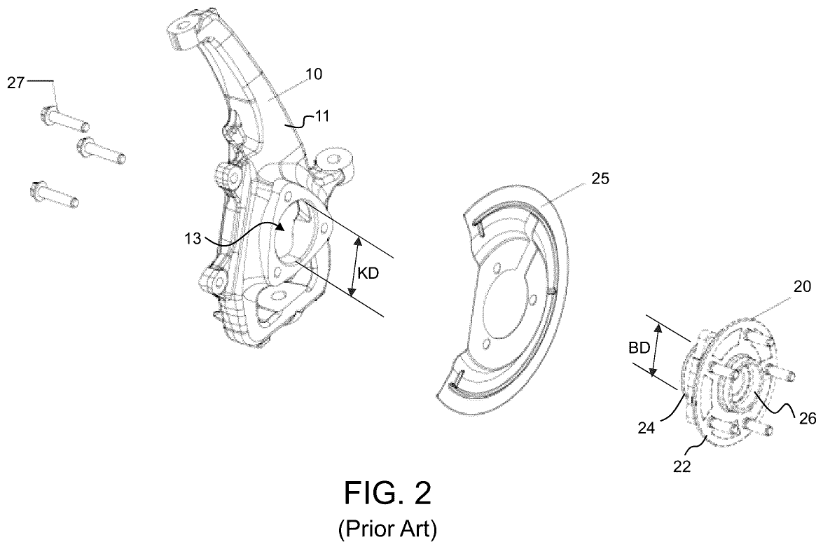

FIGS. 13 and 14 are photographs of a steering knuckle 50 in accordance with an embodiment of the invention having a steering knuckle manufactured from QT450-10 and the knuckle bore surface covered with Teflon®. FIG. 1 shows the knuckle 50 prior to salt spray testing and FIG. 14 show the knuckle 50 after 96 hours of salt spray testing. As can be seen, substantial rust and corrosion 70 developed on the machined exterior surface 51 of the body 52, while the covered wheel bearing bore 53 is not rusted.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

1. A steering knuckle configured to receive a bearing having a given outer diameter, the steering knuckle comprising:
a knuckle body having an exterior surface with a given surface treatment, the body defining a knuckle bore having an interior surface and configured to receive the bearing;
wherein at least a portion of the knuckle bore interior surface is coated with a corrosion resistant material.

2. The steering knuckle according to claim 1 wherein the corrosion resistant material is a non-metallic material.

3. The steering knuckle according to claim 2 wherein the corrosion resistant material is selected from the group comprising: paints, epoxies, polymers, composites, and thermoplastics.

4. The steering knuckle according to claim 1 wherein the corrosion resistant material is applied via brushing, spraying, e-coating, dipping or adhesion.

5. The steering knuckle according to claim 1 wherein the corrosion resistant material has a thickness between 0.05 mm to 1.0 mm.

6. The steering knuckle according to claim 1 wherein the corrosion resistant material has a thickness between 0.1 mm to 0.5 mm.

7. The steering knuckle according to claim 1 wherein the corrosion resistant material is applied to the entire knuckle bore interior surface.

8. The steering knuckle according to claim 1 wherein the at least a portion of the knuckle bore interior surface that is coated with a corrosion resistant material has a surface finish which is different than the given surface treatment.

9. The steering knuckle according to claim 1 wherein the knuckle bore interior surface defines a minimum diameter which is larger than the given outer diameter.

10. A steering knuckle assembly comprising the steering knuckle according to claim 9 and a bearing have a given outer diameter, wherein the bearing is positioned in the knuckle bore and a circumferential gap is defined between the knuckle bore interior surface and the bearing.

11. The steering knuckle assembly according to claim 10 wherein the circumferential gap has a width between 0.5 mm to 2.0 mm.

12. The steering knuckle assembly according to claim 10 wherein the circumferential gap has a width between 0.7 mm to 1.2 mm.

13. A method of treating a steering knuckle including a knuckle body having an exterior surface with a given surface treatment, the body defining a knuckle bore having an interior surface and configured to receive the bearing, the method comprising:
coating at least a portion of the knuckle bore interior surface with a corrosion resistant material.

14. The method according to claim 13 wherein the corrosion resistant material is a non-metallic material.

15. The method according to claim 14 wherein the corrosion resistant material is selected from the group comprising: paints, epoxies, polymers, composites, and thermoplastics.

16. The method according to claim 13 wherein the coating is done via brushing, spraying, e-coating, dipping or adhesion.

17. The method according to claim 13 wherein the corrosion resistant material has a thickness between 0.05 mm to 1.0 mm.

18. The method according to claim 13 wherein the corrosion resistant material has a thickness between 0.1 mm to 0.5 mm.

19. The method according to claim 13 wherein the corrosion resistant material is applied to the entire knuckle bore interior surface.

20. The method according to claim 13 wherein the at least a portion of the knuckle bore interior surface that is coated with a corrosion resistant material has a surface finish which is different than the given surface treatment.
